(19) United States
(12) Patent Application Publication
(10) Pub. No.: US 2026/0199813 A1
(43) Pub. Date: Jul. 16, 2026

(54) WATER FILTER BYPASS AND SHUTOFF

(71) Applicant: Filter Group USA Inc., Houston, TX (US)

(72) Inventors: Benjamin Seidman, Houston, TX (US); Sungyoun Oh, North York (CA); Justin Malone, Houston, TX (US); Michael Gingras, Sainte-Marie (CA); Andre Lehoux, Sainte-Marie (CA); Miguel A. Castellote, Frampton (CA)

(21) Appl. No.: 19/444,427

(22) Filed: Jan. 9, 2026

Related U.S. Application Data
(60) Provisional application No. 63/745,629, filed on Jan. 15, 2025.

(51) Int. Cl. B01D 35/30

(52) U.S. Cl. CPC B01D 35/30; B01D 2201/165; B01D 2201/302

(57) ABSTRACT

Disclosed examples generally relate to a bypass and shutoff assembly for use with a filtration apparatus. In at least one example, the assembly includes a first three-way valve comprising, (i) a first valve inlet, (ii) a first valve main outlet, and (iii) a first valve bypass outlet; a second three-way valve comprising, (i) a second valve main inlet, (ii) a second valve bypass inlet, and (iii) a second valve outlet; and a bypass conduit providing fluid communication between the first valve bypass outlet and the second valve bypass inlet.

### BACKGROUND

The present invention relates to bypass and shutoff device for use with a water filtration system.

### BACKGROUND

Water filtration systems installed at a “point of entry” location are a type of filtration system that is installed at the point where water enters a home or building, typically at the main water line. This system filters all the water that enters the premise.

It is often necessary to allow water to bypass the filter system or to temporarily shut off water to the filter system, for the purpose of repairs, maintenance or to change a filter element. As these filter systems are integrally installed into the plumbing system, bypassing or shutoff of water flow is inconvenient or difficult.

### SUMMARY

In one aspect, disclosed is a bypass and shutoff system for use with a water supply and a filtration system having an inlet pipe and an outflow pipe, the bypass and shutoff system comprising:
(a) a first three way valve having an inlet, a main outlet and a bypass outlet;
(b) a second three way valve having a main inlet, a bypass inlet and an outlet,
(c) a bypass pipe providing fluid communication between the first valve bypass outlet and the second valve bypass inlet;
wherein the first valve inlet is connected to the water supply, the first valve main outlet is connected to the filtration system inlet pipe, the second valve main inlet is connected to the filtration system outflow pipe.

The first valve may be positioned in one of three positions:
a. Closing off the inlet, so that no water flows through the first valve;
b. closing the second outlet, thereby allowing flow from the inlet to the first outlet, such that water flows from the inlet into the filtration system; and
c. closing the first outlet, thereby allowing flow from the inlet to the second outlet, such that water flows into the bypass valve.

The second valve may be positioned in one of three positions:
a. Closing off the outlet, so that no water flows through the second valve.
b. Closing off the bypass inlet, thereby allowing flow from the main inlet to the outlet;
c. Closing off the main inlet, thereby allowing from the bypass inlet to the outlet.

Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

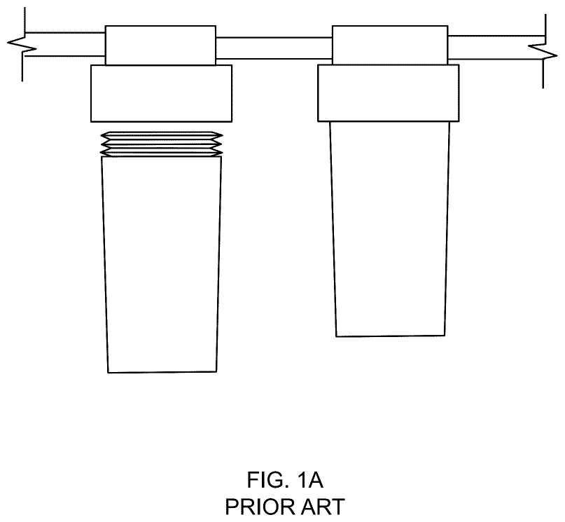

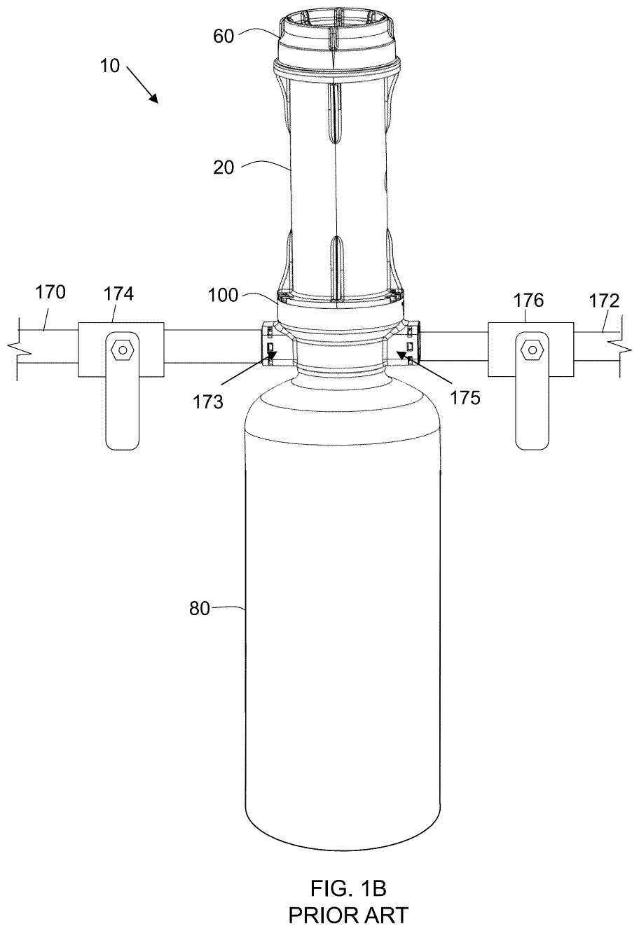

(a) FIG. 1A is a depiction of a conventional point-of-entry water filtration system (Prior Art); FIG. 1B is a depiction of another point-of-entry water filtration system, showing conventional shutoff valves (Prior Art).

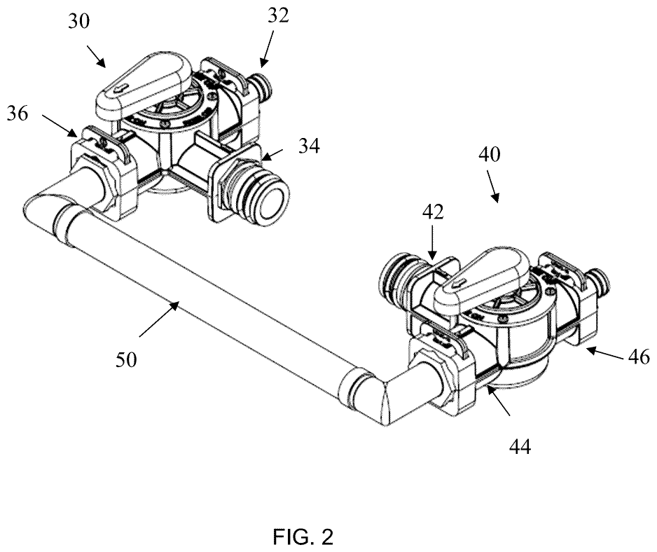

(b) FIG. 2 is a depiction of one embodiment of a bypass and shutoff system.

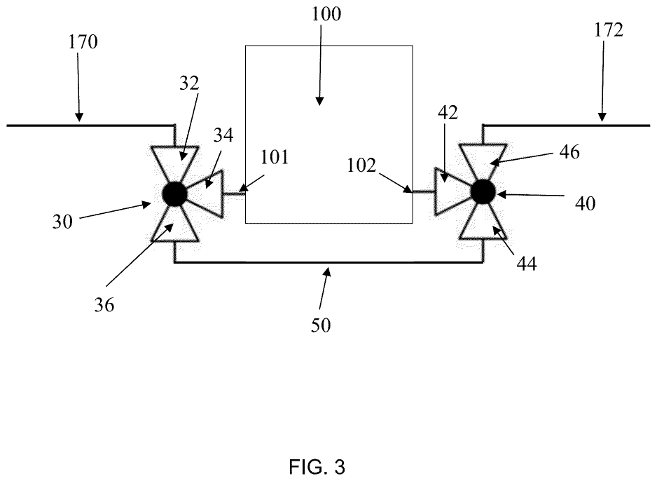

(c) FIG. 3 is a schematic depiction of the first and second valves, the filtration system and the bypass pipe.

### DETAILED DESCRIPTION

The present invention now will be described more fully hereinafter with reference to the accompanying drawings, in which some, but not all embodiments of the invention are exemplified. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

FIGS. 1A and 1B shows an embodiment of an apparatus (10) for filtering water, which comprises a housing (20), a lid (60), a tank (80), a distributor (100), and a filter contained within the housing (20). The apparatus can generally be a filtering apparatus as shown and described in co-owned U.S. Pat. No. 10,786,764, entitled “Water Filtration Apparatus with Top-Loading Filter Cartridge Housing”, the entire contents of which are incorporated herein by reference.

The housing (20) is tubular and defines a housing interior that extends vertically from a housing bottom end to a housing top end. The housing top end defines a housing top end opening that is sized to allow a tubular filter cartridge to be inserted into and removed from the housing interior.

Tubular filter cartridges are known to persons of ordinary skill in the art of water filtration systems, and are available in a variety of sizes, and may contain a variety of different types of filtration media. As a non-limiting example, the filter cartridge (40) may be a “pre-filter” made of polypropylene, for removing particulate contaminants such as sediment and rust particles from water. As another non-limiting example, the filter cartridge (40) may contain granular activated carbon for removing chlorine, heavy metals, and volatile organic compounds from water.

The filtering apparatus distributor 100 is connected to an intake line 170 having a shutoff valve 174 and an outlet line 172, having a shutoff valve 176. As may be seen, the distributor has an inlet 173 and outlet 175, which are opposed and substantially aligned, both vertically and horizontally.

Embodiments of the present invention provide an alternative to the shutoff valves 174 and 176 of the prior art.

An exemplary embodiment is shown in FIG. 2. A bypass and shutoff system for use with a water supply and a filtration system having an inlet pipe and an outflow pipe is shown. The bypass and shutoff system has a general “U” shape, which permits connection to a filtration system distributor having an opposing inlet and outlet configuration.

The system comprises:
(a) a first three-way valve 30 having an inlet 32, a main outlet 34 and a bypass outlet 36;
(b) a second three-way valve 40 having a main inlet 42, a bypass inlet 44 and an outlet 46,
(c) a bypass pipe 50 providing fluid communication between the first valve bypass outlet 36 and the second valve bypass inlet 44;
wherein the first valve inlet 32 is connected to the water supply 170, the first valve main outlet 34 is connected to the distributor inlet 101, the second valve main inlet 42 is connected to the distributor outlet 102.

In preferred embodiments, the first valve main outlet 34 and the second valve main inlet are configured to mate with the distributor inlet and outlet respectively, where the distributor inlet and outlet are opposed but aligned. Therefore, the first valve main outlet 34 and the second valve main inlet 42 are aligned vertically and horizontally.

The first valve 30 may be positioned in one of three positions:
a. closing off the inlet 32, so that no water flows through the first valve 30;
b. closing the bypass outlet 36 and opening the main outlet 34 (normal operation), thereby allowing flow from the inlet 32 to the main outlet 34, such that water flows from the inlet 32 into the filtration system distributor 100; and
c. closing the main outlet 34, thereby allowing flow from the inlet 34 to the bypass outlet 36, such that water flows into the bypass pipe 50 (bypass operation).

The second valve 40 may be positioned in one of three positions:
a. closing off the outlet 46, so that no water flows through the second valve 40.
b. Closing off the bypass inlet 44, thereby allowing flow from the main inlet 42 to the outlet 46 (normal operation);
c. Closing off the main inlet 42, thereby allowing from the bypass inlet 44 to the outlet 46 (bypass operation).

Therefore, in normal operation, the first valve is in position b. described above and the second valve is in position b. described above. As this is a point-of-entry system, closing the first valve (position a.) will turn off all water to the system.

To bypass the water filtration system, the first valve may be moved to position c. as well as the second valve is also moved to its position c. Thus, the water filtration system may be repaired or maintained as necessary, with water still flowing through the bypass 50 and to the rest of the building.

Embodiments of the bypass and shutoff system may be retrofitted to existing filtration systems. One skilled in the art will appreciate that the dimensions and relative positioning can be modified as necessary to fit an existing water filtration system, of the type shown in FIGS. 1A and/or 1B.

### Interpretation

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims. Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should further be appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

The terms longitudinal, lateral, and transverse may be used to denote motion or spacing along three mutually perpendicular axes, wherein each of the axes defines two opposite directions. The directions defined by each axis may also be referred to as positive and negative directions. Additionally, the descriptions that follow may refer to the directions defined by the axes with specific reference to the orientations illustrated in the figures. For example, the directions may be referred to as distal/proximal, left/right, and/or up/down. It should be appreciated that such terms may be used simply for ease and convenience of description and, therefore, used without limiting the orientation of the system with respect to the environment unless stated expressly to the contrary. For example, descriptions that reference a longitudinal direction may be equally applicable to a vertical direction, a horizontal direction, or an off-axis orientation with respect to the environment. Furthermore, motion or spacing along a direction defined by one of the axes need not preclude motion or spacing along a direction defined by another of the axes. For example, elements described as being “laterally offset” from one another may also be offset in the longitudinal and/or transverse directions, or may be aligned in the longitudinal and/or transverse directions. The terms are therefore not to be construed as further limiting the scope of the subject matter described herein.

1. A bypass and shutoff assembly for use with a filtration apparatus, comprising:
a first three-way valve comprising, (i) a first valve inlet, (ii) a first valve main outlet, and (iii) a first valve bypass outlet;
a second three-way valve comprising, (i) a second valve main inlet, (ii) a second valve bypass inlet, and (iii) a second valve outlet; and
a bypass conduit providing fluid communication between the first valve bypass outlet and the second valve bypass inlet.

2. The assembly of claim 1, wherein the filtration apparatus comprises an inflow pipe and an outflow pipe which are diametrically opposed.

3. The assembly of claim 2, wherein,
the first valve inlet is couplable to a water supply inlet conduit,
the first valve main outlet is couplable to the inflow pipe of the filtration apparatus, and
the second valve main inlet is couplable to the outflow pipe of the filtration apparatus.

4. The assembly of claim 3, wherein, the second valve outlet is couplable to a water outlet distribution conduit.

5. The assembly of claim 3, wherein the filtration apparatus includes a distributor comprising the inlet pipe and outflow pipe.

6. The assembly of claim 1, wherein the first valve main outlet and the second valve main inlet are spaced apart to define a filtration apparatus receiving area.

7. The assembly of claim 6, wherein the first valve main outlet and the second valve main inlet are aligned along a common alignment axis, and are axially spaced along the alignment axis to define the filtration apparatus receiving area.

8. The assembly of claim 6, wherein the bypass conduit traverses around the filtration receiving area.

9. The assembly of claim 8, wherein the assembly has a generally “U” shape configuration.

10. The assembly of claim 1, wherein the first valve is configurable into one of three valve positional configurations, comprising:
a first position, configured for closing off the first valve inlet;
a second position, configured for closing off the first valve bypass outlet; and
a third position, configured for closing the first valve main outlet.

11. The assembly of claim 10, wherein in the first position, water is prevented from flowing through the first valve inlet.

12. The assembly of claim 10, wherein in the second position, water is permitted to flow from the first valve inlet to the first main outlet, such that water flows from the first valve inlet into the filtration apparatus.

13. The assembly of claim 10, wherein in the third position, water is permitted to flow from the first valve inlet to the first valve bypass outlet, such that water flows into the bypass conduit.

14. The assembly of claim 1, wherein the second valve may be positioned in one of three valve positional configurations, comprising:
a first position, configured for closing off the second valve outlet;
a second position configured for closing off the second valve bypass inlet; and
a third position configured for closing off the second valve main inlet.

15. The assembly of claim 14, wherein in the first position, water is prevented from flowing out of the second valve.

16. The assembly of claim 14, wherein in the second position, water is permitted to flow from the second valve main inlet to the second valve outlet.

17. The assembly of claim 14, wherein in the third position, water is permitted to flow from the second valve bypass inlet to the second valve outlet.

18. The assembly of claim 1, wherein the filtration apparatus comprises a point-of-entry filtration apparatus.

19. A water filter and bypass system, comprising:
the bypass and shutoff assembly of claim 1; and
the filtration apparatus, wherein
the first valve main outlet of the assembly is coupled to the inlet pipe of the filtration apparatus, and
the second valve main inlet of the assembly is coupled to the outflow pipe of the filtration apparatus.

20. A kit, comprising:
the bypass and shutoff assembly of claim 1; and
a filtration apparatus.
